(19) United States
(12) Patent Application Publication
(10) Pub. No.: US 2012/0091872 A1
(43) Pub. Date: Apr. 19, 2012

(54) SYNCHRONOUS GUIDE OF A PUSH MEMBER AND PIECE OF FURNITURE

(75) Inventors: Joachim Matthes, Kirchlengern (DE); Henrik Knicker, Bunde (DE)

(73) Assignee: PAUL HETTICH GMBH & CO. KG, Kirchlengern (DE)

(21) Appl. No.: 13/378,716

(22) PCT Filed: Jun. 23, 2010
(86) PCT No.: PCT/EP10/58892

§ 371 Date: Dec. 16, 2011

(30) Foreign Application Priority Data
Jul. 6, 2009 (DE) 20 2009 004 993.0
Nov. 25, 2009 (DE) 20 2009 016 105.6

(51) Int. Cl. A47B 88/12; F16H 19/04

(52) U.S. Cl. 312/334.8; 74/89.17

(57) ABSTRACT

A synchronous guide of a drawer element mounted on a body of a piece of furniture or household appliance via pullout guides. The synchronous guide includes two stationary toothed racks located opposite each other, each toothed rack associated with a side member of the body. Further included are two gear wheels, each of which is mounted on one of the pullout guides, the gear wheels being connected via a coupling rod. The gear wheels are mounted in a stationary manner on running rails of the pullout guides. A piece of furniture or household appliance includes a drawer element mounted on a body of the piece of furniture or household appliance via pullout guide and includes a synchronous guide as described above.

This application is a national stage of International Application PCT/EP2010/058892, filed Jun. 23, 2010, and claims benefit of and priority to German Patent Application No. 20 2009 004 993.0, filed Jul. 6, 2009 and German Patent Application No. 20 2009 016 105.6 filed Nov. 25, 2009, the content of which Applications are incorporated by reference herein.

### BACKGROUND AND SUMMARY

The present disclosure relates to a synchronous guide of a drawer element mounted in a body of a piece of furniture or household appliance by way of pullout guides. The synchronous guide includes two stationary toothed racks located opposite each other, each toothed rack associated with a side member of the body. Also included are two gear wheels, each of which is mounted on one of the pullout guides, the gear wheels being connected via a coupling rod. The present disclosure also relates to a piece of furniture or household appliance including a drawer element mounted on a body of the piece of furniture or household appliance via pullout guides and including a synchronous guide.

In order to ensure the even displacement of a drawer element on both sides, synchronous guides are used, which are generally arranged as rack-and-pinion gears, with one respective toothed rack being fastened to the respectively opposite side members of the body, with which an associated gear wheel will mesh in the rear region of the drawer element. As a result, canting of the drawer element is effectively prevented when being pulled out or pushed in.

The gear wheels are connected with one another in a torsionally rigid fashion by a coupling rod in order to achieve synchronous rolling of the gear wheels.

In generic synchronous guides, the gear wheel is mounted on the drawer element in the rear region of the drawer element.

Problems can arise in this arrangement in such a way that during subsequent mounting of the synchronous guide it is necessary to dismount the drawer element first in order to fasten the gear wheel in the rear region of the drawer element. In other examples of generic synchronous guides, it is necessary to provide the synchronization in a laborious manner in the installed drawer element.

The present disclosure thus also relates to a synchronous guide of a drawer element which is mounted in the body of a piece of furniture or household appliance by way of pullout guides and which can be mounted in a simple and therefore cost-effective way.

The present disclosure further relates to a synchronous guide of a drawer element mounted on a body of a piece of furniture or household appliance via pullout guides. The synchronous guide includes two stationary toothed racks located opposite each other, each toothed rack associated with a side member of the body. Further included are two gear wheels, each of which is mounted on one of the pullout guides, the gear wheels being connected via a coupling rod. The gear wheels are mounted in a stationary manner on running rails of the pullout guides. The present disclosure further relates to a piece of furniture or household appliance including a drawer element mounted on a body of the piece of furniture or household appliance via pullout guides and includes a synchronous guide as described above.

In accordance with the embodiments of the present disclosure, the gear wheels of the synchronous guide are mounted in a stationary manner on the running rails of the pullout guides. As a result, the synchronous guide can be mounted considerably more easily in the body since the synchronous guide can be mounted completely on the pullout guides and the drawer element merely needs to be fastened thereafter to the running rails of the pullout guides.

Additional features are noted in the description herein including the claims.

In accordance with an embodiment of the present disclosure, each of the gear wheels is held in a bracket fastened to the respective running rail. This enables simple mounting of the gear wheels because they can be mounted on the bracket before the fastening of the drawer element to the running rail of pullout guide.

In accordance with another embodiment of the present disclosure, the bracket includes a head part which partly encloses the running rail and a throat part which extends perpendicularly to the longitudinal axis of the running rail in the direction of the guide. A bearing for accommodating the gear wheel is arranged at an end of the throat part which is spaced from the head part. As a result of the arrangement of the bracket, it can be slid easily onto the running rail.

At least one snap-in hook is mainly formed on the running rail, which hook can be latched into a latching tongue provided on the head part of the bracket. As a result, the bracket can be fixed by latching in the simplest possible manner after sliding the bracket onto the running rail. Other interlocked, frictionally or materially engaged connections between the bracket and the running rail are within the scope of the present disclosure.

In accordance with another embodiment of the present disclosure, the toothed racks are fixed beneath guide rails of the pullout guides which are connected with the body in a stationary manner and can be latched into angles fastened to the body. This allows simple and rapid mounting of the toothed racks on the body. The angles are simultaneously also used for fixing the guide rail to the body.

In another embodiment according to the present disclosure, the toothed racks are fastened by a holding element on an end region of the guide rail facing the rear wall of the body.

The attachment of the toothed racks in the manner as explained above in accordance with the present disclosure, further allows an arrangement of the toothed rack as a prefabricated part which can be shortened to the required longitudinal dimension and can then be fastened to the guide rail.

In accordance with another embodiment of the present disclosure, a track guide, which encloses the toothed rack at least partly, is formed on the throat part of the bracket for radially and/or axially limiting the movement of the gear wheel in relation to the toothed rack. This ensures a secure engagement of the gear wheel in the toothed rack.

Other aspects of the present disclosure will become apparent from the following descriptions when considered in conjunction with the accompanying drawings.

### BRIEF DESCRIPTION OF THE DRAWINGS

FIGS. 1 and 2 show schematic perspective views of a pullout guide with an embodiment of a synchronous guide, in accordance with the present disclosure.

FIG. 3 shows a detailed view of the pullout guide of FIG. 1.

FIG. 4 shows a perspective, partially exploded view of the embodiment of the synchronous guide and the pullout guide of FIGS. 1 and 2.

FIG. 5 shows a schematic front view of the pullout guide with the synchronous guide of FIG. 1 arranged thereon.

FIG. 6 shows a perspective view of an embodiment of the bracket of the synchronous guide of FIGS. 1 and 2.

FIGS. 7a to 7c show perspective views of a detail of the embodiment of the synchronous guide of FIGS. 1 and 2 and illustrating a toothed rack fixture in accordance with the present disclosure.

FIG. 8 shows a perspective view of a drawer element which is slid into the body and includes an embodiment of the synchronous guide of FIGS. 1 and 2.

FIG. 9 shows a perspective view of the body with the synchronous guide of FIG. 8 without the drawer element.

FIG. 10 shows a perspective view of a drawer element which is pulled out of the body and includes a synchronous guide fastened to the pullout guide, in accordance with the present disclosure.

FIG. 11 shows a perspective view of the arrangement as shown in FIG. 10, not including the drawer element but with the pullout guide of FIG. 10 that is partly pulled out.

FIG. 12 shows a perspective view of the arrangement of FIG. 10 not showing the drawer element but with the pullout guide that is fully pulled out.

FIGS. 13 and 14 show schematic perspective detailed views of the synchronous guide of FIG. 10 fastened to the pullout guide.

FIGS. 15 and 16 show schematic perspective views of the synchronous guide shown in FIGS. 13 and 14.

FIGS. 17 and 18 show schematic perspective views illustrating an embodiment of a fastening variant of a toothed rack on the guide rail of the pullout guide, according to the present disclosure.

FIG. 19 shows a schematic perspective view of a pullout guide with a synchronous guide arranged thereon, in accordance with the present disclosure.

FIGS. 20 to 22 show schematic perspective views illustrating the mounting and dismounting of a drawer element from a furniture body, in accordance with the present disclosure.

### DETAILED DESCRIPTION

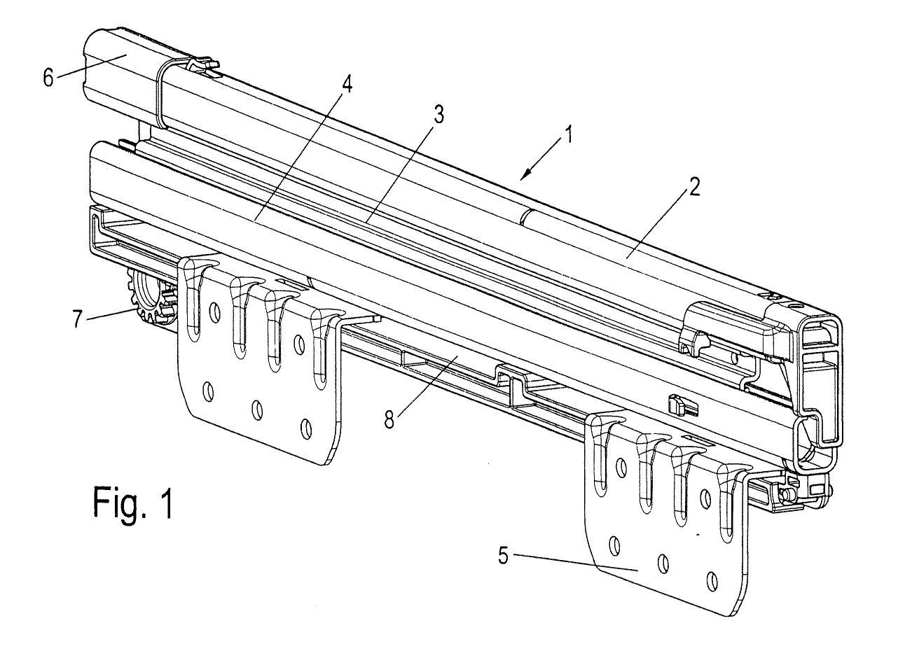

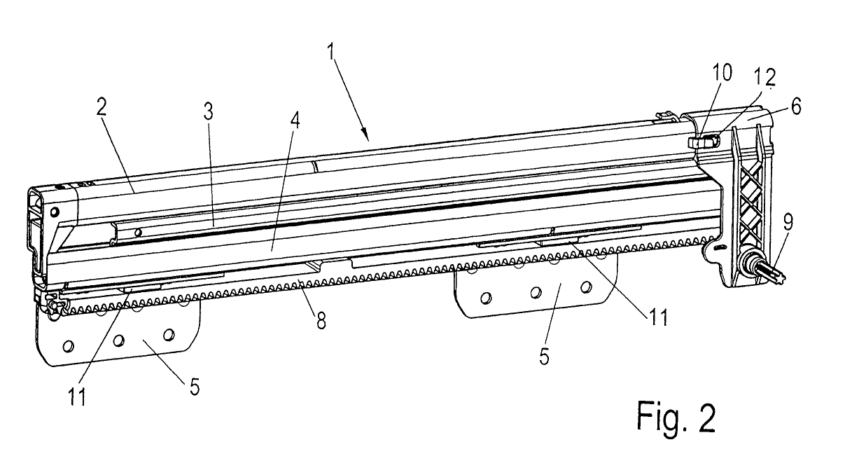

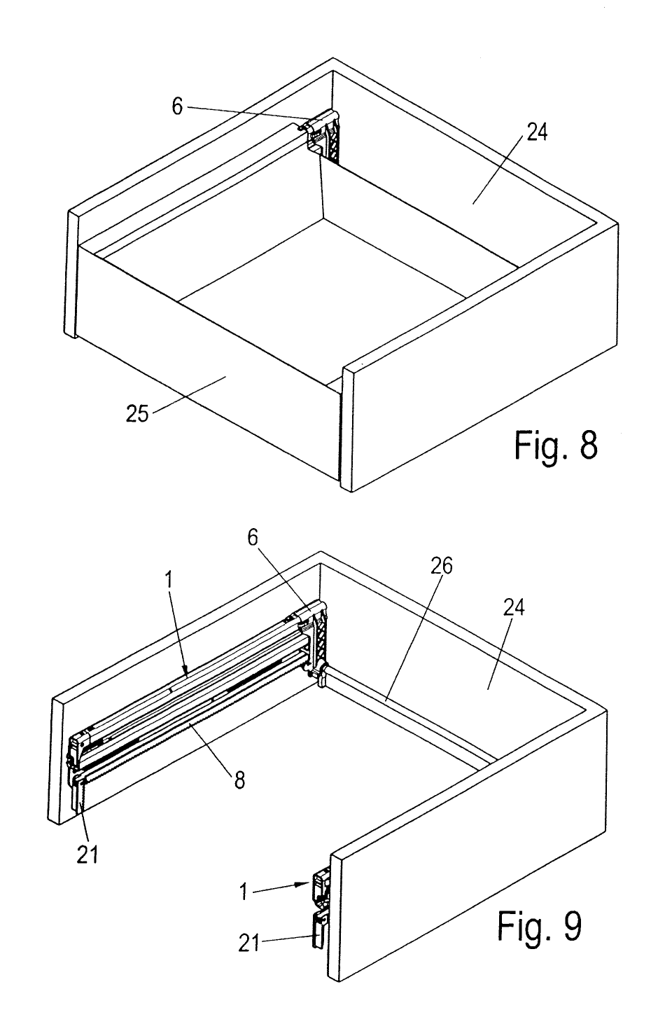

FIGS. 1 and 2 show a pull-out guide 1 and including an embodiment of a synchronous guide arranged thereon, which is used for displaceably mounting a drawer element 25, as shown in FIG. 8, for example, in a body 24. The body 24 may relate to the body of a piece of domestic furniture, such as a piece of office furniture or kitchen furniture, or a kitchen appliance, such as a refrigerator. The pullout guide 1 includes a guide rail 4 which is fixed to the body 24 and a running rail 2 which is displaceable on the guide rail 4.

In order to enable full extension, a middle rail 3, which extends the pullout can, in accordance with the present disclosure be arranged in the pullout guide 1 between the guide rail 4 and the running rail 2.

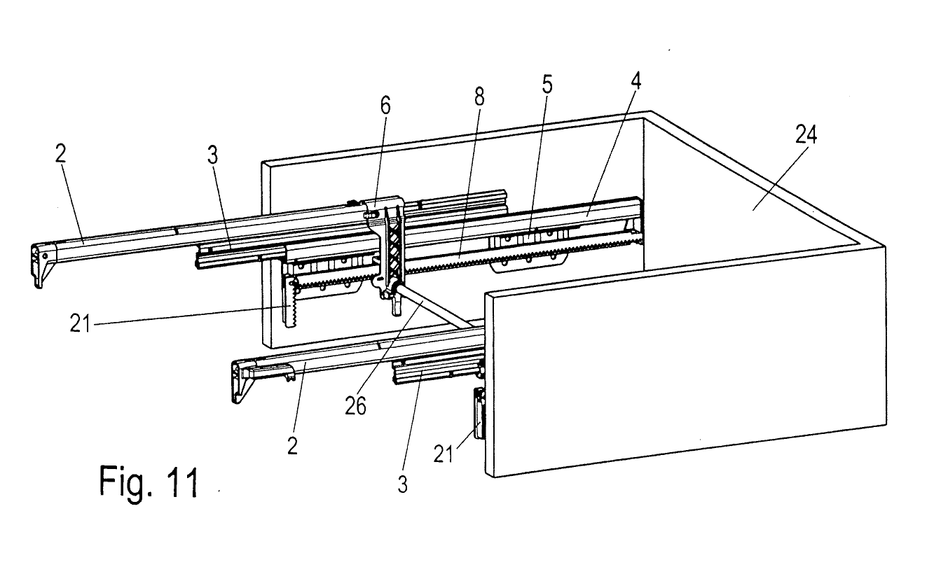

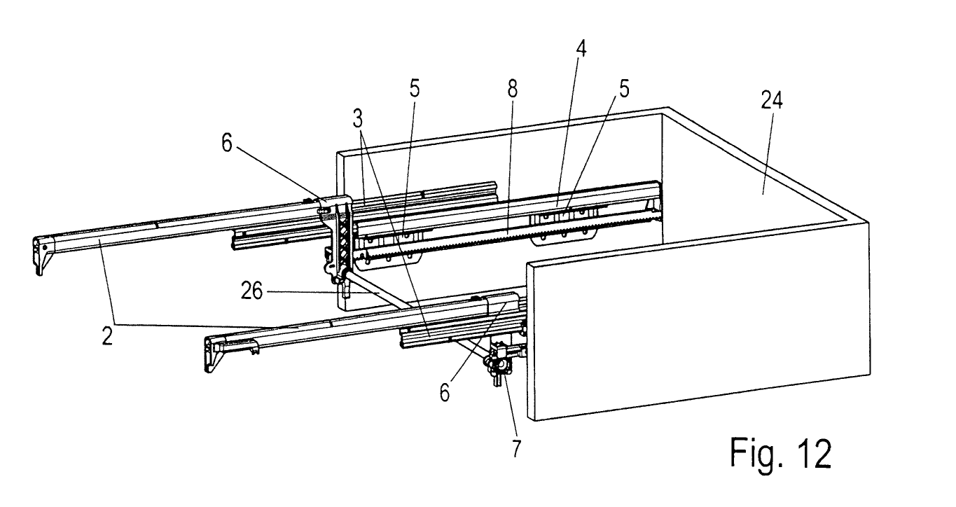

To illustrate the principle of operation of the synchronous guide, FIGS. 8 to 12 show different positions of the pullout guide 1, with a synchronous guide fastened thereto, in the body 24, with and without the drawer element 25.

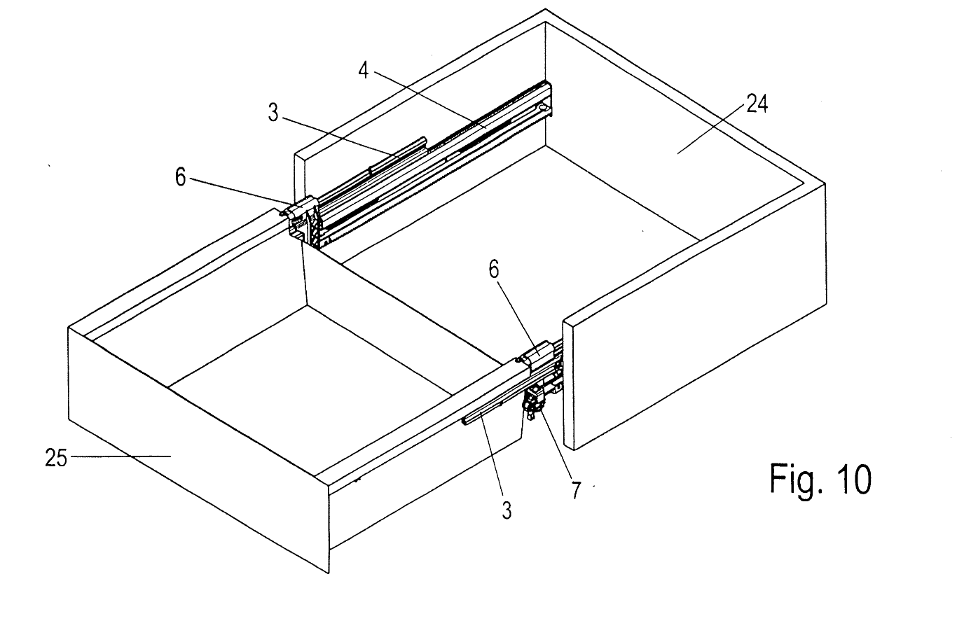

The synchronous guide includes two toothed racks 8 which are opposite of one another, associated with one respective side member of the body 24 and fixed in a stationary manner to guide rail 4 of the pullout guide 1. Two gear wheels 9 are connected in a torsion-proof manner with one another by way of a coupling rod 26, as shown in FIG. 9, for example. In contrast to the synchronous guides known from the state of the art, the gear wheels 9 are not mounted on the drawer element 25, but are mounted in a stationary manner on the running rails 2 of the pullout guides 1.

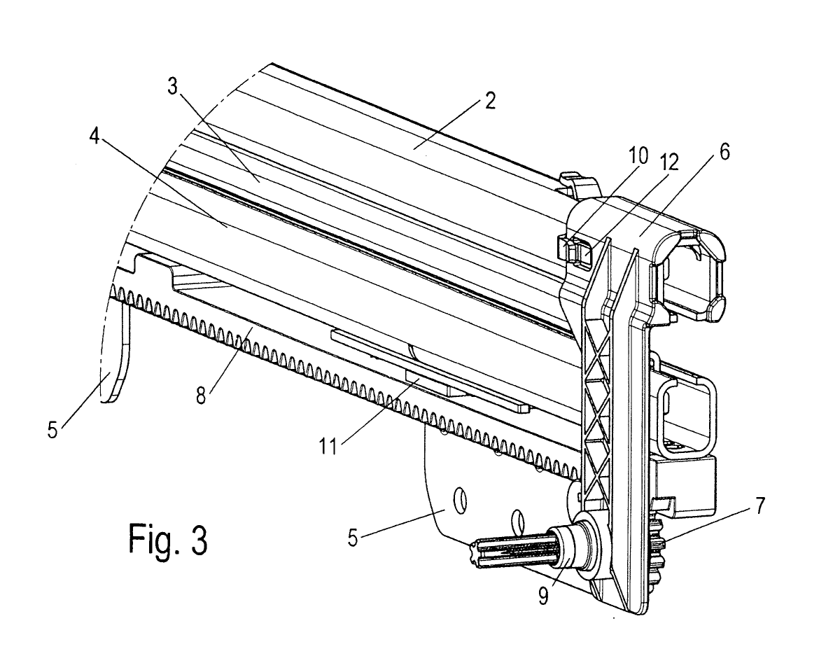

In the embodiment as shown, for example, in FIGS. 2 and 3, the gear wheels 9 are mounted in a bracket 6 fixed to the respective running rail 2. The toothed racks 8 are fastened beneath the guide rails 4 of the pullout guide 1, with the manner of the fastening discussed below. The guide rails 4 themselves are fixed by angles 5 to the body 24.

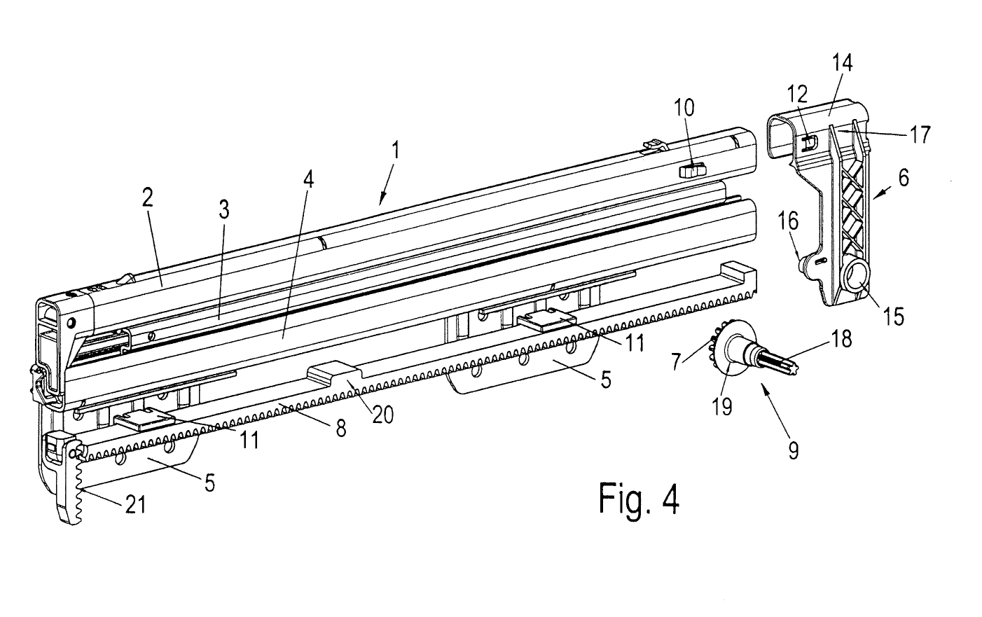

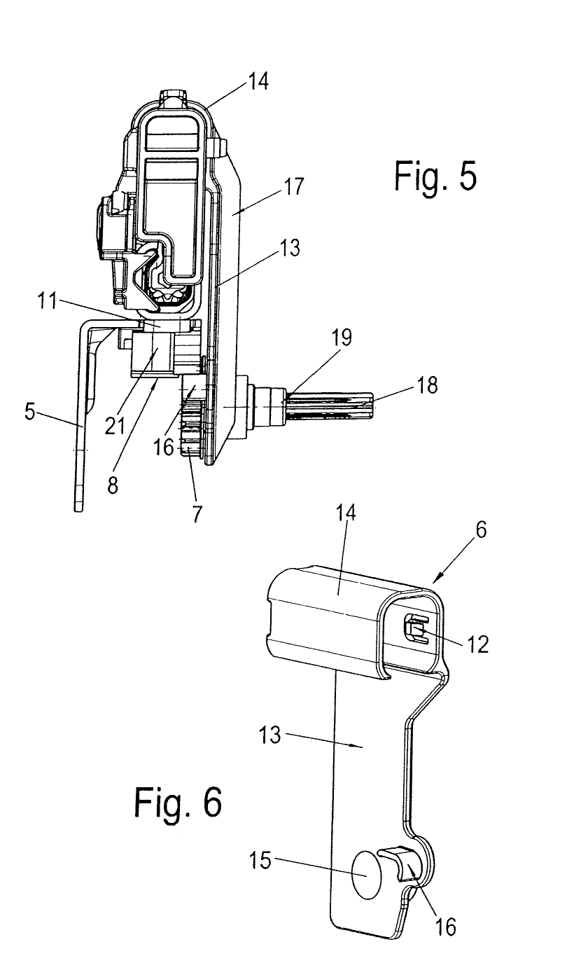

As is shown in FIGS. 3 and 4, the bracket 6 includes a head part 14 which partly encloses the running rail 2 and a throat part 13 which extends perpendicularly to the longitudinal axis of the running rail 2 in the direction of the guide rail 4. A bearing point 15 for accommodating the gear wheel 9 is arranged on an end of the throat part 13 which is spaced from the head part 14.

In order to lock the bracket 6 on the running rail 2, at least one snap-in hook 10 is formed on the running rail 2, which presses a snap-in tongue 12 that is provided on the head part 14 of the bracket 6 into the recess of the running rail 2. In order to stabilize the throat part 13 of the bracket 6, which is also shown as an individual element in FIG. 6 for illustration, stabilizing webs 17 are formed on a side of the throat 13 which faces away from the pullout guide 1.

As is shown in FIGS. 4 and 6, a web 16, which protrudes perpendicularly from the inside surface of, and is formed on, the throat part 13 on the side which faces the pullout guide 1. A toothed rack element 21, which can be pivoted on the toothed rack 8 at an end close to the front of the drawer, can be positioned from a position standing perpendicularly to the longitudinal axis of the toothed rack 8 to a position continuing in the longitudinal direction of the toothed rack 8. In order to prevent interlocking with the gearing of the toothed rack element 21, the web 16 is downwardly provided in the pullout direction of the pullout guide 1 with a radius. The web 16 lifts the toothed rack element 21 in a preceding fashion in order to ensure secure travel of the gear wheels 9 in the overextension. An overextended position of the drawer element 25 relative to the body 24 is enabled with the downwardly foldable toothed rack element 21.

The gear wheel 9 includes a cylindrical element 19 with a plate-like front surface, on which the teeth 7 of the gear wheel 9 are formed on the side facing away from the cylindrical element 19. An adapter element 18 with a star-shaped cross-section is inserted into the cylindrical element 19, on which the coupling rod 26 can be inserted in interlocking fashion with corresponding recesses, so that the coupling rod 26 is connected in a torsion-proof manner with the gear wheels 9 in order to ensure synchronous travel of the gear wheels 9 on the ends of the coupling rod 26.

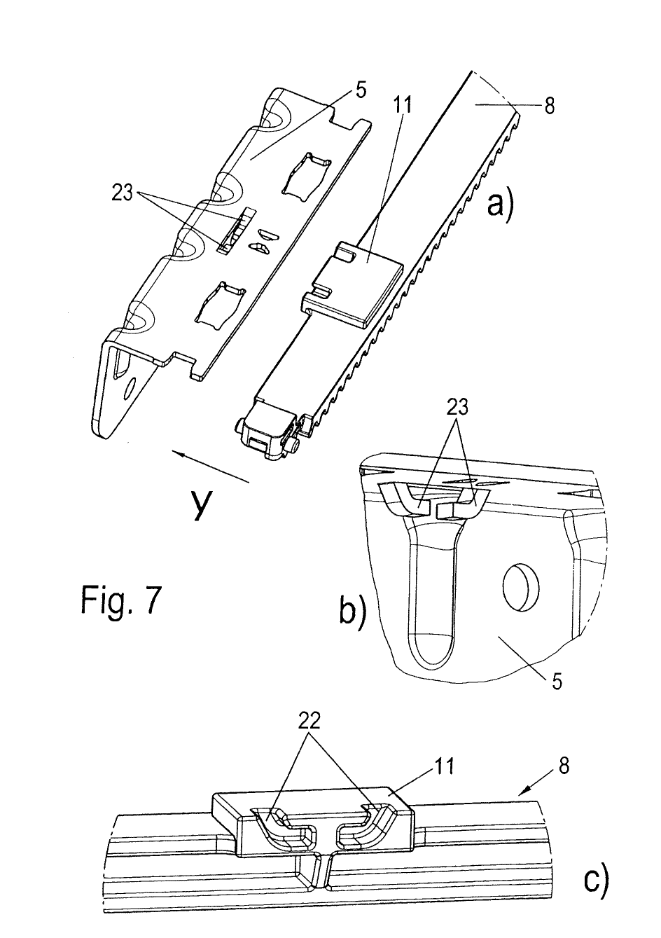

As is shown in FIGS. 7a to 7c, the toothed rack 8 can be latched together with the angles 5 fixed to the body 24 in an embodiment of the synchronous guide, according to the present disclosure. For this purpose, hooks 23 protrude from the side of the angles 5 which face away from the guide rail 4, which hooks 23 engage in interlocking cutouts 22 of an adapter element 11 formed on the opposite side of the gearing of the toothed rack 8, so that the toothed rack 8 can be slid onto the hooks 23 of the angles 5 perpendicularly to the sliding direction of the pullout guides 1, in the mounting direction Y. In order to prevent deflection of the toothed rack 8 by pressing the gear wheel 9 against the toothed rack 8, enlarged portions 20 (see FIG. 4) are formed in predetermined intervals on the side opposite of the gearing of the toothed rack 8 in an embodiment according to the present disclosure.

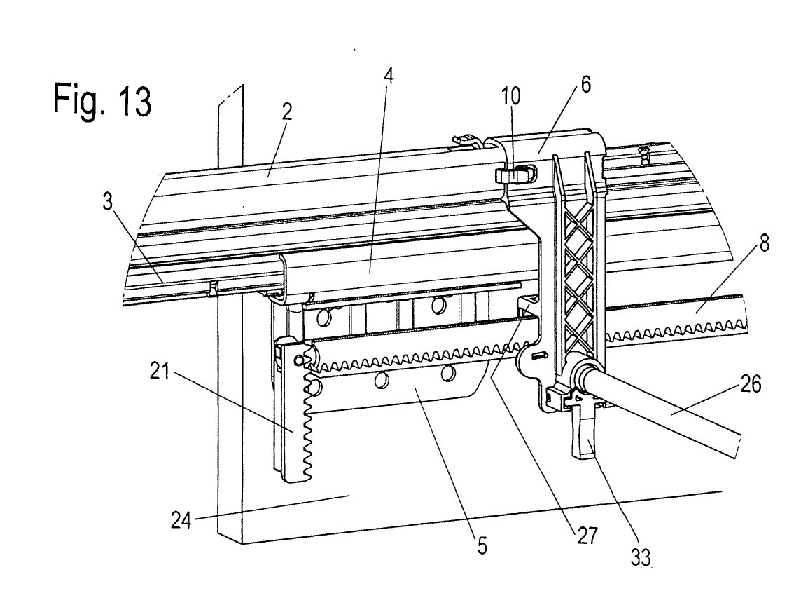

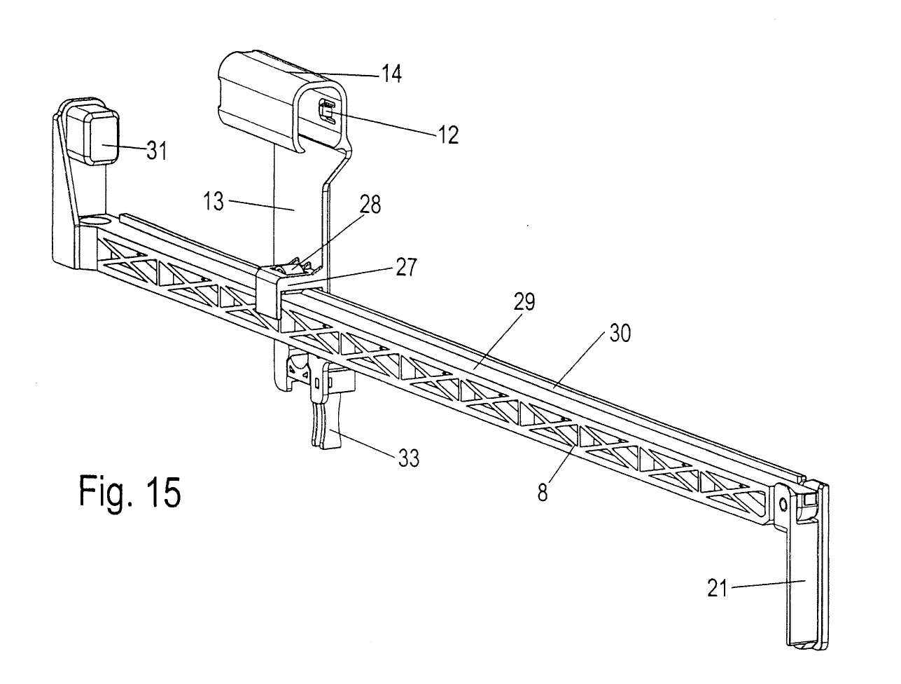

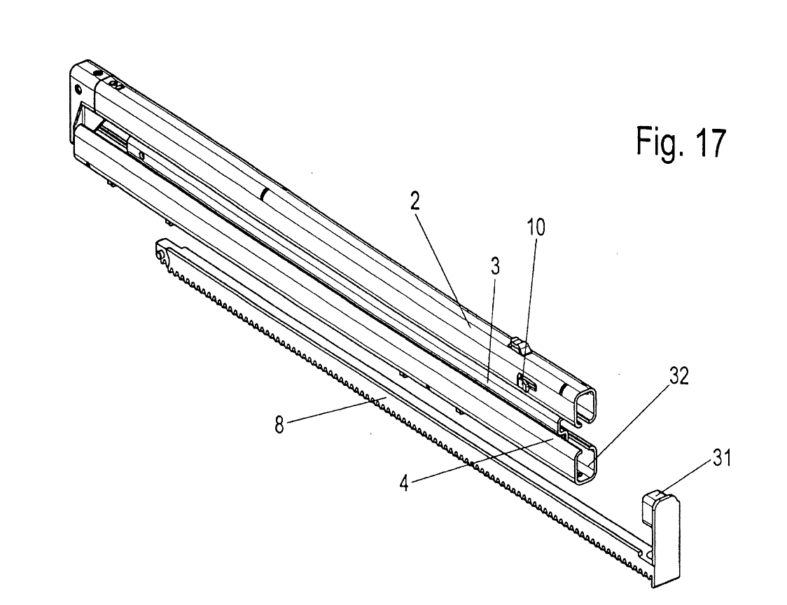

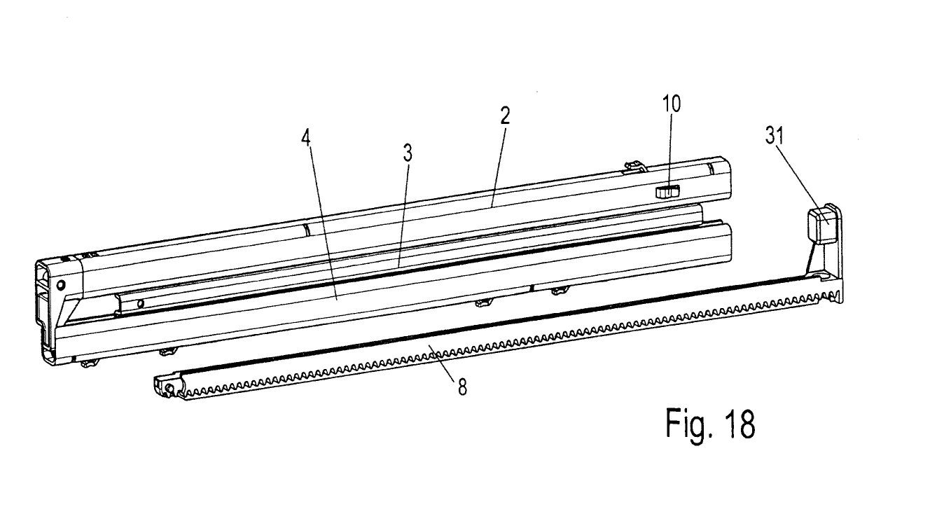

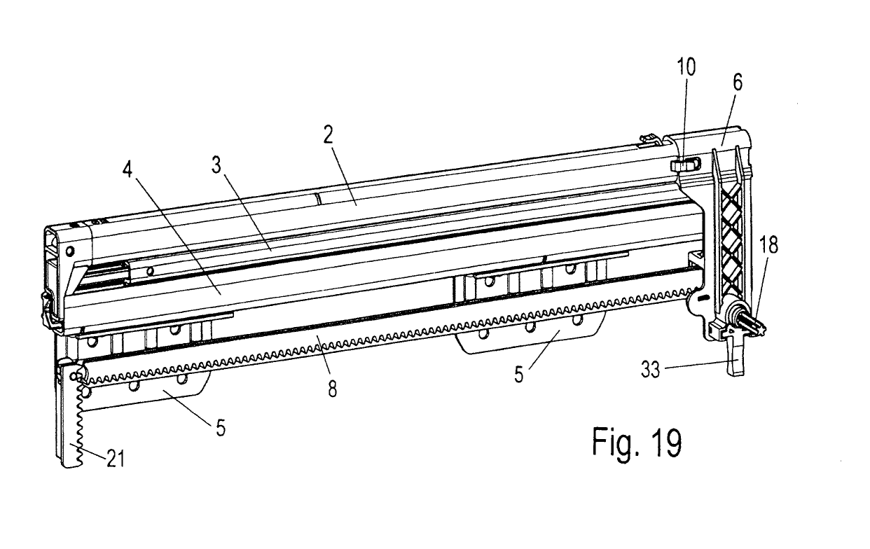

In an embodiment of the synchronous guide according to the present disclosure, as shown in FIGS. 13 to 19, the toothed rack 8 is fixed to an end of the guide rail 4 which is close to the rear wall of the body 24. As is shown in closer detail, especially in FIGS. 17 and 18, a holder 31 is fixed to or formed on the guide rail 4 at the end of the toothed rack 8 which is remote from the toothed rack element 21. The holder 31 stands at first perpendicularly to the longitudinal axis of the toothed rack 8 in the direction of the guide rail 4 and includes a head part at its end which can be inserted in an interlocking fashion in a face opening 32 of the guide rail 4.

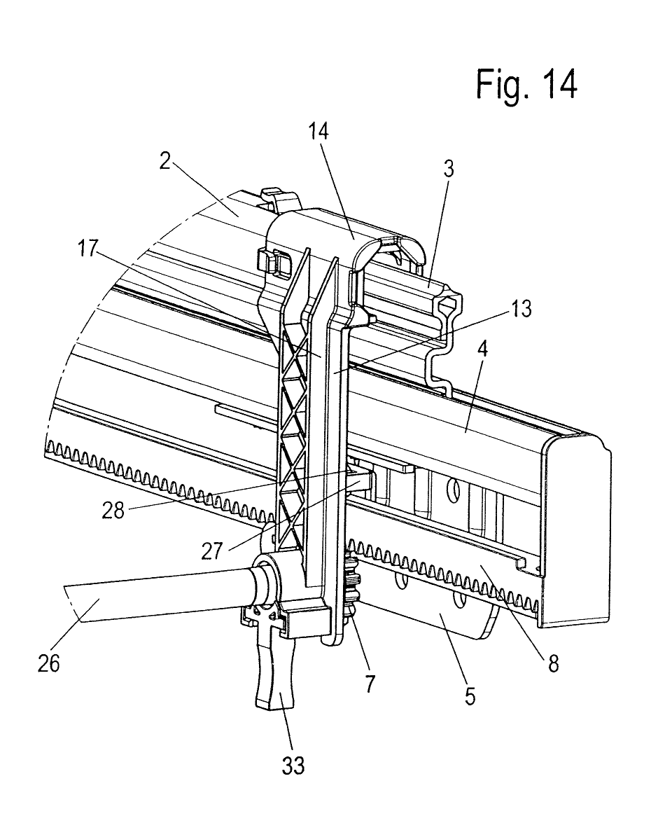

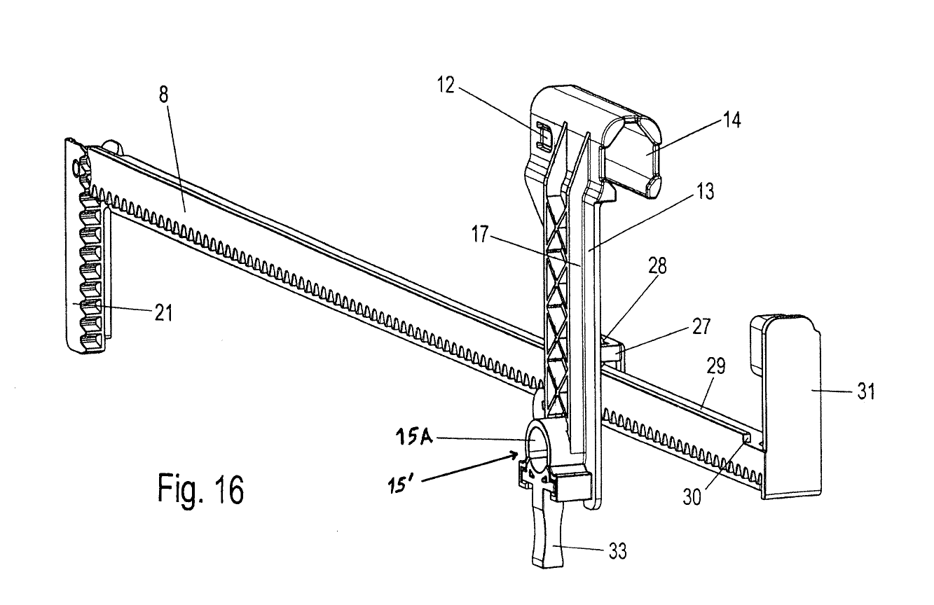

In order to ensure a functionally reliable engagement of the gear wheels 9 into the toothed racks 8 in this kind of fixing of the toothed rack 8, the bracket 6 is formed on the throat part 13 with a track guide 27 (see FIG. 16) which encloses the toothed rack 8 at least partly for the purpose of limiting the radial and/or axial movement of the gear wheel 9 in relation to the toothed rack 8. As is shown in FIGS. 14-16 which shows the bracket 6 and the toothed rack 8, the track guide 27 includes a running roller 28 which can be moved on a track 29 on the side of the toothed rack 8 which faces away from the gearing. The track 29 is provided with a lateral guide 30 at least in one longitudinal edge for axially limiting the movement of the gear wheel 9. The track guide 27 is arranged in the manner of a bracket around the toothed rack 8 on the side of the track 29 which is opposite of the lateral guide 30.

As is shown in FIG. 16, the bearing point 15′ for accommodating the gear wheel 9 is not arranged as a bore which is enclosed in its circumference in the embodiment as shown in FIGS. 2-4, but as a divided bearing point 15′ which includes a first bearing point element 15A which is arranged slightly more than semi-spherical in the throat 13, into which a closure element 33 can be slid. The first bearing point element 15A is arranged in such a way that the gear wheels 9 can snap in during mounting and are able to possibly fall out of the bearing point 15′ until locking is performed with the closure element 33. As a result of this bearing point 15′, which is arranged in the shape of an omega, the coupling rod 26, with the already premounted gear wheel 9, can be pressed from below into the bearing point 15′ and can be sealed subsequently by inserting the closure element 33 into the receiver extending transversely to the longitudinal axis of the throat 30.

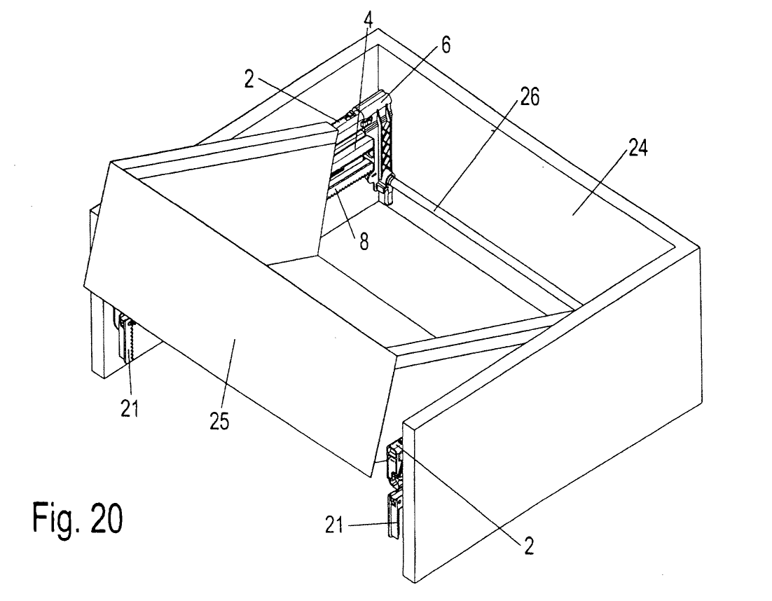

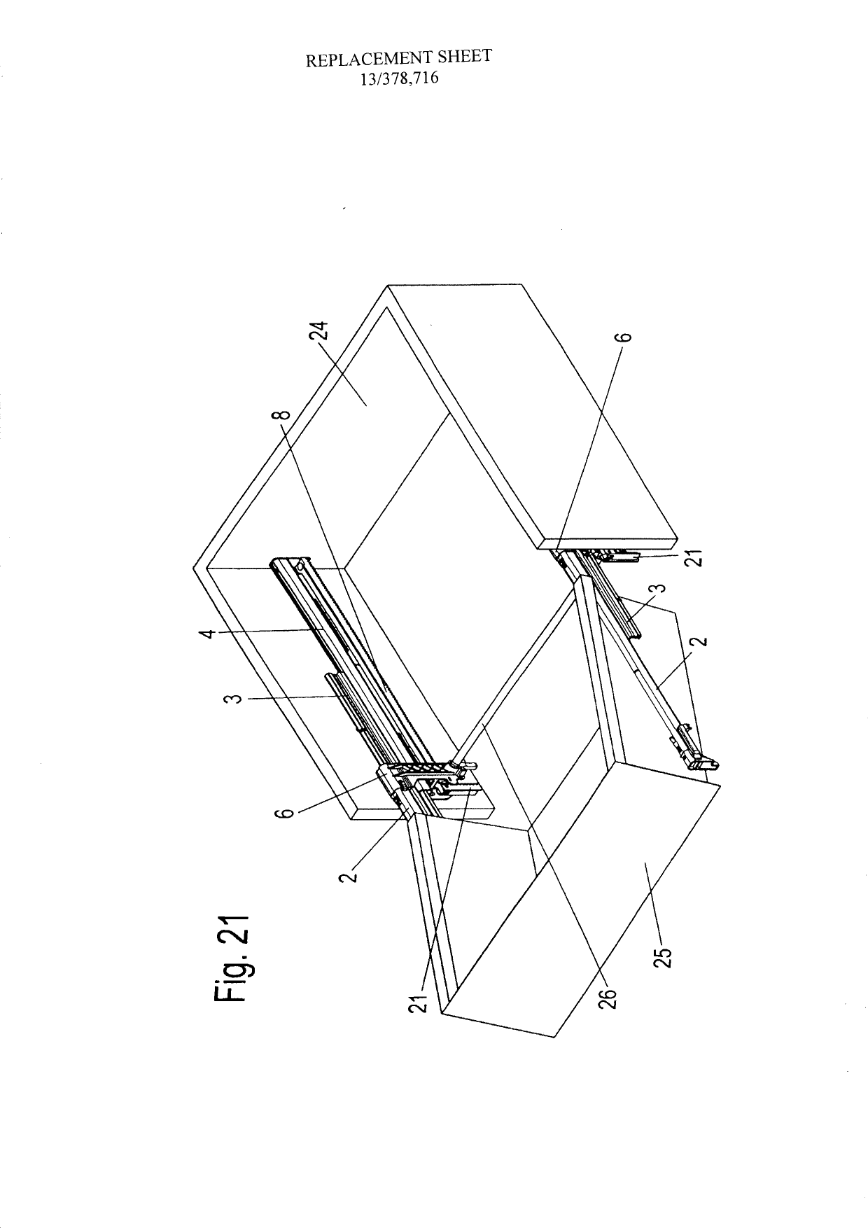

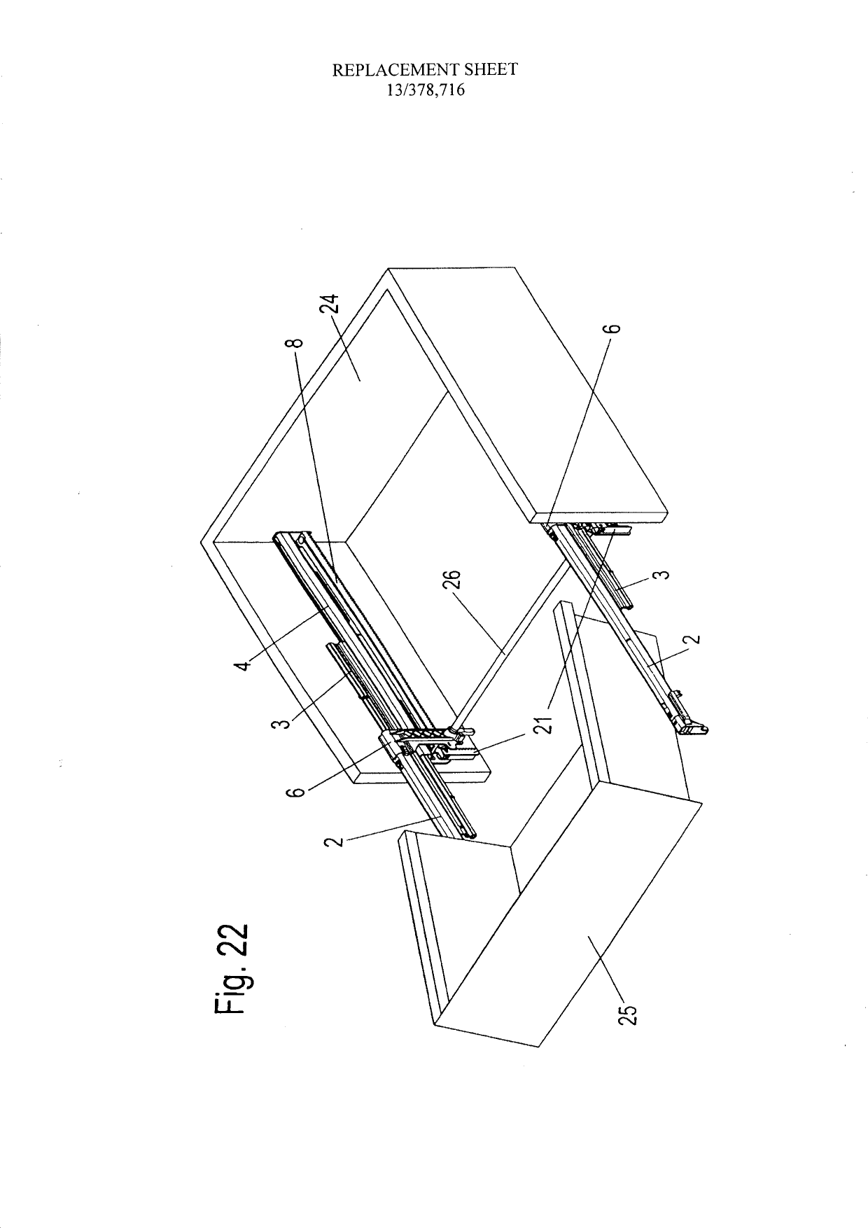

FIGS. 20 to 22 illustrate the simple mounting and dismounting of drawer element 25 from a body 24 which is provided with an embodiment of the synchronous guide, in accordance with the present disclosure, which is only fastened to the pullout guides 1. As is shown, the drawer element 25 can be mounted or dismounted independent of the synchronous guide on or from the pullout guides 1. Furthermore, the removed drawer element 25 offers sufficient space for mounting the synchronous guide. Easy removal of a drawer element 25 from a refrigerating appliance for cleaning purposes, for example, is therefore easily possible. The synchronous guide need not be newly adjusted after removal and mounting of drawer elements 25.

Although the present disclosure has been described and illustrated in detail, it is to be clearly understood that this is done by way of illustration and example only and is not to be taken by way of limitation. The scope of the present disclosure is to be limited only by the terms of the appended claims.

We claim:

1. A synchronous guide of a drawer element mounted on a body of a piece of furniture or household appliance via pullout guides, the synchronous guide comprising:
two stationary toothed racks located opposite each other, each toothed rack associated with a side member of the body;
two gear wheels, each of which is mounted on one of the pullout guides, the gear wheels being connected via a coupling rod; and
wherein the gear wheels are mounted in a stationary manner on running rails of the pullout guides.

2. The synchronous guide according to claim 1, wherein each of the gear wheels is held in a bracket fastened to a respective one of the running rails.

3. The synchronous guide according to claim 2, wherein the bracket includes a head part which partly encloses the respective one of the running rails and a throat part which extends perpendicularly to a longitudinal axis of the respective running rail in a direction of a guide rail of the pullout guide, with a recess configured to accommodate one of the gear wheels arranged at an end of the throat part which is spaced from the head part.

4. The synchronous guide according to claim 3, wherein at least one snap-in hook is formed on the respective running rail, which hook is configured to be locked in a snap-in tongue provided on the head part of the bracket.

5. The synchronous guide according to claim 3, wherein the toothed racks are fastened beneath the guide rails of the pullout guides, which guide rails are connected in a stationary manner with the body.

6. The synchronous guide according to claim 3, wherein the toothed racks include a gearing on a side which faces away from the pullout guides.

7. The synchronous guide according to claim 3, wherein the toothed racks are configured to be snap-locked into angles fastened to the body.

8. The synchronous guide according to claim 3, wherein the toothed racks are fastened by a holder to an end region of the guide rail facing a rear wall of the body.

9. The synchronous guide according to claim 8, wherein the holder and the guide rail are connected in an interlocking manner with each other.

10. The synchronous guide according to claim 8, wherein the holder is formed on an end of the toothed rack.

11. The synchronous guide according to claim 8, wherein the holder and the toothed rack are connected in an interlocking manner with each other.

12. The synchronous guide according to claim 3, wherein a track guide, which encloses the toothed rack at least partly, is formed on the throat part of the bracket for one or both of radially and axially limiting a movement of the gear wheels in relation to the toothed racks.

13. The synchronous guide according to claim 12, wherein the track guide includes a running roller configured to be moved on a track on a side of the toothed rack which faces away from a gearing of the toothed rack.

14. The synchronous guide according to claim 13, wherein the track is provided on at least one longitudinal edge with a lateral guide.

15. The synchronous guide according to claim 3, wherein ends of a coupling rod are configured to be fastened in a bearing point of the throat part of the bracket.

16. The synchronous guide according to claim 15, wherein the bearing point is arranged as a bore.

17. The synchronous guide according to claim 15, wherein the bearing point is arranged in the shape of an omega, and further wherein the coupling rod is configured to be pressed into a part of a recess which is arranged as a sector of a circle, and an open part of the bearing point is configured to be closed off by a closure element.

18. A piece of furniture or household appliance comprising:
a drawer element mounted on a body oldie piece of furniture or household appliance via pullout guide; and
a synchronous guide in accordance with claim 1.
